(19) United States
(12) Patent Application Publication
(10) Pub. No.: US 2018/0099477 A1
(43) Pub. Date: Apr. 12, 2018

(54) REINFORCED COMPOSITE STRUCTURE AND METHODS OF MAKING THE SAME

(71) Applicant: Foam Supplies, Inc., Earth City, MO (US)

(72) Inventors: Marion Blair, Vonore, TN (US); Todd Keske, Earth City, MO (US); Don Keim, Earth City, MO (US)

(21) Appl. No.: 15/729,991

(22) Filed: Oct. 11, 2017

Related U.S. Application Data
(60) Provisional application No. 62/406,675, filed on Oct. 11, 2016.

(51) Int. Cl. B32B 5/24; B32B 5/02; B32B 5/20; B32B 17/06; B32B 27/32; B32B 37/26

(52) U.S. Cl. CPC B32B 5/245; B32B 2038/0084; B32B 5/20; B32B 17/064; B32B 17/066; B32B 27/32; B32B 37/26; B32B 2255/02; B32B 2255/26; B32B 2260/021; B32B 2260/046; B32B 2262/101; B32B 2266/0278; B32B 2605/12; B32B 2605/18; B32B 5/024

(57) ABSTRACT

A reinforced composite structure and a method of making a reinforced composite structure are disclosed herein. The structure and methods disclosed herein include a reinforcing flexible material, a barrier layer, and a foam. The barrier layer can be perforated. The foam can pass through the barrier layer to contact and adhere or bond to the reinforcing flexible material. The structure and methods according to the disclosure are useful, for example, in any structural boat component such as stringers, bulkheads, hull and deck stiffeners, beams, fuel tank supports, structural members, long-span stiffeners, corner stiffeners, hull side-to-bottom strengthening, hatch and swim platform reinforcement, insulated compartments, fish boxes, and applications for flat-bed trailers, truck bodies, buses, recreational vehicles, or other types of vehicles, such as aircrafts.

### CROSS-REFERENCE TO RELATED APPLICATIONS

The present application claims the benefit of U.S. Provisional Application Ser. No. 62/406,675, filed 11 Oct. 2016, which is incorporated herein by reference in its entirety.

### FIELD OF THE INVENTION

The present disclosure generally relates to a reinforced composite structure and a method for producing a reinforced composite structure. The structure and methods disclosed herein are useful, for example, in boat stringer and deck applications.

### BACKGROUND OF THE INVENTION

In this specification where a document, act or item of knowledge is referred to or discussed, this reference or discussion is not an admission that the document, act or item of knowledge or any combination thereof was at the priority date, publicly available, known to the public, part of common general knowledge, or otherwise constitutes prior art under the applicable statutory provisions, or is known to be relevant to an attempt to solve any problem with which this specification is concerned.

Preformed reinforced products, such as stringers for marine applications, and methods for making the same have been developed. A woven or knit fabric layer is placed into a molding structure. A spray foam is applied to the fabric layered inside the molding structure and covered to provide a composite structure. Current and previous methods required the use of halogenated blowing agents such as HCFC-22 or HFC-134a. Low-pressure two-component spray foams using halogenated hydrocarbons have been used to give the current attributes for preformed structural composites.

The problem with conventional methods of making preformed composite products, and similar methods known in the art, is that they rely on the use of foam materials that comprise harmful greenhouse gases, such as chlorofluorocarbons (CFCs), hydrochlorofluorocarbons (HCFCs), hydrofluorocarbons (HFCs), and hydrocarbons. Additionally, any foam that has a liquid phase causes the foam to saturate (overwet) the reinforcing material before it expands. Further, some foam products (e.g., foams using liquid blowing agents (LBAs)) have been found to be unsuitable because the foam or liquid phase allows for the foam to expand into the reinforcing material, deforming the product and making it unusable. Additionally, excessive wetting of the reinforcing material has shown to have deleterious effects such as deformation of the reinforcing material or causing insufficient resin coating, such as, for example, a composite coating (e.g., an epoxy resin) from adhering properly to the opposite side of the flexible material (i.e., the side of the material not in direct contact with the foam).

Foams comprising CFCs, HCFCs, HFCs, and hydrocarbons are known to damage the ozone layer. Accordingly, there is a need for a reinforced composite material and methods for reinforcing a composite structure that do not employ the use of foam materials comprising harmful greenhouse gases.

Because the applications for the reinforced composite material is unique with very specific performance, flow, and cure requirements, until now, it has not been possible to make the preformed composite materials that meet Significant New Alternatives Policy Program (SNAP) requirements under EPA's new rule Protection of Stratospheric Ozone: Proposed New Listings of Substitutes; Changes of Listing Status; and Reinterpretation of Unacceptability of Closed Cell Foam Products under the Significant New Alternatives Policy Program; and Revision of Clean Air Act Section 608 Venting Prohibition for Propane, published at 81 Fed. Reg. 22810 (Apr. 18, 2016).

### SUMMARY OF THE INVENTION

Among the various aspects of the present disclosure is the provision of a reinforced composite structure and methods of making a reinforced composite structure.

One embodiment provides a method for producing a reinforced composite structure including a flexible material, a barrier layer, and a foam reaction mixture.

Another embodiment provides a reinforced composite structure including a flexible material, a barrier layer, and a foam.

One embodiment provides a method, the method including providing a reinforcing flexible material, providing a barrier layer, and providing a foam reaction mixture. The barrier layer is placed between the reinforcing flexible material and the foam reaction mixture. The barrier layer includes at least one pore and the foam reaction mixture expands through the at least one pore such that the foam contacts and adheres to the reinforcing flexible material.

In further embodiments, provided is a structure, comprising a reinforcing flexible material, a barrier layer comprising a first surface, a second surface, and a pore, the second surface positioned such that it contacts the reinforcing flexible material, and a foam in contact with the first surface of the barrier layer and the reinforcing flexible material and positioned such that it extends through the pore of the barrier layer to contact the reinforcing flexible material.

Another embodiment provides a reinforced composite structure or a method of producing a reinforced composite structure wherein the barrier layer comprises at least one pore or a plurality of pores; the foam reaction mixture comprises a liquid blowing agent (LBA) or a gas blowing agent (GBA); or the reinforcing flexible material comprises at least one material selected from the group consisting of a fiberglass, a carbon fiber, an aramid fiber, a polyethylene fiber, a polypropylene fiber, a polyester fiber, and a mixture thereof.

Another embodiment provides a method of producing a reinforced composite structure wherein the foam is obtained by combining an isocyanate; at least one polyol having a hydroxyl number of from about 150 to about 800 and is selected from the group consisting of a polyalkoxylated amine, a polyalkoxylated ether, and a polyester polyol; or at least one blowing agent selected from the group consisting of methyl formate, a derivative of methyl formate, or a precursor of methyl formate. Another embodiment provides a method of producing a reinforced composite structure wherein the combining further comprises adding water as a blowing agent.

Another embodiment provides a reinforced composite structure or a method of producing a reinforced composite structure wherein the foam or foam reaction mixture is substantially free of a halogenated hydrocarbon, optionally, hydrofluoroolefin (HFO), hydrochlorofluoroolefin (HCFO), chlorofluorocarbon (CFC), a hydrochlorofluorocarbon (HCFC), or hydrofluorocarbon (HFC).

Another embodiment provides a reinforced composite structure or a method of producing a reinforced composite structure wherein the reinforcing flexible material comprises at least one material selected from the group consisting of a fiberglass, a carbon fiber, an aramid fiber, a polyethylene fiber, a polypropylene fiber, a polyester fiber, and a mixture thereof. Another embodiment includes, the reinforcing flexible material comprising a woven fiberglass.

Another embodiment provides a reinforced composite structure or a method of producing a reinforced composite structure wherein the barrier layer comprises a plurality of pores or is a plastic sheet.

Another embodiment provides a reinforced composite structure or a method of producing a reinforced composite structure further comprising a composite coating. In further embodiments, provided is a reinforced composite structure or a method of producing a reinforced composite structure where the reinforcing flexible material has a first side and a second side and the first side is in contact with the barrier layer and the second side is in contact with a composite coating.

Another embodiment provides a reinforced composite structure or a method of producing a reinforced composite structure wherein the barrier layer is semi-permeable or selectively permeable.

In other embodiments, the structure includes a barrier layer which comprises a plurality of pores, a the foam reaction mixture which comprises a liquid blowing agent or a gas blowing agent; or a reinforcing flexible material which comprises at least one material selected from the group consisting of a fiberglass, a carbon fiber, an aramid fiber, a polyethylene fiber, a polypropylene fiber, a polyester fiber, and a mixture thereof.

In further embodiments, the structure includes a foam or foam reaction mixture that comprises an isocyanate, at least one polyol having a hydroxyl number of from about 150 to about 800 and is selected from the group consisting of a polyalkoxylated amine, a polyalkoxylated ether, and a polyester polyol; and at least one blowing agent selected from the group consisting of methyl formate, a derivative of methyl formate, and a precursor of methyl formate. Another embodiment provides a foam that further comprises water as a blowing agent. In yet further embodiments, the foam is substantially free of a halogenated hydrocarbon, optionally, a hydrofluoroolefin, a hydroflurochloroolefin, a chlorofluorocarbon, a hydrochlorofluorocarbon, or a hydrofluorocarbon.

In other embodiments, the structure includes a reinforcing flexible material that comprises at least one material selected from the group consisting of a fiberglass, a carbon fiber, an aramid fiber, a polyethylene fiber, a polypropylene fiber, a polyester fiber, and a mixture thereof. In yet other embodiments, the reinforced flexible material is a woven fiberglass. In other embodiments, the reinforcing flexible material has a first side and a second side and the first side is in contact with the barrier layer and the second side is in contact with a composite coating.

In yet further embodiments of the structure, the barrier layer prevents the reinforcing flexible material from deforming. In other embodiments, the barrier layer prevents the reinforcing flexible material from overwetting from the foam.

In other embodiments, provided is a portion of a watercraft or vehicle, comprising a reinforcing flexible material, a barrier layer comprising a first surface, a second surface, and a pore, the second surface positioned such that it contacts the reinforcing flexible material, and a foam in contact with the first surface of the barrier layer and the reinforcing flexible material and positioned such that it extends through the pore of the barrier layer to contact the reinforcing flexible material. In further embodiments, the portion is selected from a stringer, a bulkhead, a hull, a deck stiffener, a beam, a fuel tank support, a structural member, a long-span stiffener, a corner stiffener, a hatch and swim platform reinforcement, an insulated compartment, a fish box, a structural component for a flat-bed trailer, a structural component for a truck body, a structural component for a bus, a structural component for a recreational vehicle, and a structural component for an aircraft.

Other objects and features will be in part apparent and in part pointed out hereinafter.

### DESCRIPTION OF THE DRAWINGS

Those of skill in the art will understand that the drawings, described below, are for illustrative purposes only. The drawings are not intended to limit the scope of the present teachings in any way.

FIG. 1 is an illustration of an example of the placement of the reinforcing flexible material 300, a barrier layer 200, and a foam 100.

### DETAILED DESCRIPTION OF THE INVENTION

The present disclosure is based, at least in part, on the discovery that a perforated plastic barrier used between a liquid foam reaction mixture and a woven fiberglass sheet would result in improved adhesion of the foam to the woven fiberglass sheet, but without the undesired consequences of oversaturating (i.e., over-wetting) the woven fiberglass sheet. In many applications, it is desirable to have the opposite side of the woven material (i.e., the side not in contact with the perforated plastic barrier and the foam) be available for the application of composite coating, such as an epoxy resin that binds to the outside of the woven material.

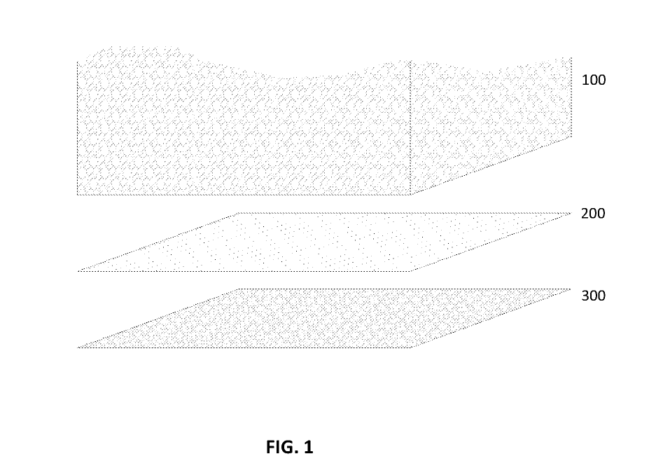

As described herein, the methods and compositions can use reinforcing flexible material (e.g., woven materials, such as a high-quality fiberglass knit fabric), polyurethane foam (e.g., a polyurethane foam, such as a 2 PCF flotation grade foam), a barrier layer (e.g., a perforated plastic sheet), and a resin (e.g., epoxy, polyester veil). As shown in FIG. 1, the barrier layer 200 is placed in between the reinforcing flexible material 300 and the foam 100. The reinforcing flexible material (e.g., fiberglass knit fabric) can be placed inside a mold in order to create pre-formed, standard shape and size components. The fiberglass knit fabric itself can be shaped to form any shape (e.g., the frame of the hull, hatch, or other component of a boat, or to create any custom product). A barrier layer can be then placed on top of the reinforcing flexible material. The foam reaction mixture (e.g., liquid polyurethane foam reaction mixture, LBA blown foam, or GBA blown foam) can be then applied into the mold or frame lined with the reinforcing flexible material and barrier layer. Once cured, the structure can be coated with a composite such as a resin (e.g., epoxy, polyurethane veil).

Certain embodiments of the present invention allow for the creation of an extremely strong interface between the fiberglass and foam without the deformation of or over-wetting the reinforcing flexible material by using the barrier layer. The methods as described herein can support dynamic loads, resist cracking, resist wear, and/or allow the product to be extremely lightweight.

The compositions and methods as described herein can also provide floatation and structure.

For example, the methods and compositions as described herein can use a blown foam (e.g., an alkyl alkanoate such as methyl formate blown foam) that has been previously shown to not be suitable for use in marine applications, such as stringers, as well as in commercial refrigerated trucks and other transportation uses. For applications, such as stringers, the foam can be placed on top of a reinforcing flexible material.

Applications of the materials as described herein can include any structural boat component such as stringers, bulkheads, hull and deck stiffeners, beams, fuel tank supports, structural members, long-span stiffeners, corner stiffeners, hull side-to-bottom strengthening, hatch and swim platform reinforcement, insulated compartments, or fish boxes. As another example, applications of the materials as described herein can include structural components for vehicles, including flat-bed trailers, truck bodies, buses, recreational vehicles, and aircraft such as, for example, airplanes, helicopters, ultralights, gliders, and drones.

Further aspects, features and advantages of the embodiments will become apparent from the detailed description which follows.

Reinforcing Flexible Material

As described herein, a reinforced composite structure can comprise a reinforcing flexible material (e.g., fabric layer), a barrier layer, and a foam. The reinforcing flexible material can comprise a first surface and a second surface.

For example, the reinforcing flexible material can be any material known in the art suitable for use in producing a reinforced composite structure as described herein. For example, the reinforcing flexible material can be a fabric layer. The fabric layer can be made of materials known to those having ordinary skill in the art. For example, the fabric layer can be comprised of one or more of a fiberglass, a carbon fiber, an aramid fiber, a polyethylene fiber, a polypropylene fiber, a polyester fiber, a combination or mixture thereof and the like. In an exemplary embodiment, the fabric layer can be a fiberglass mat. For example, fiberglass mat can be woven roving or chopped glass mat. As another example, the fabric layer can include, but is not limited to, a woven fabric, cotton, polyester, and/or cotton polyester blends, optionally coated with absorbent or super absorbent polymer formulations. As another example, the reinforcing flexible materials can be any type of material sufficient for use in stringer systems for boats or process of making the same.

As another example, the fabric layer can comprise fibers that are natural, modified natural, synthetic, or a combination thereof. In some embodiments, the fabric layer can be a woven fabric, a knitted fabric, a felt, a mesh of cross-linked fiber polymers, or a combination thereof. In some embodiments, the natural fibers are selected from the group consisting of cotton, wool, hemp, tree fiber, other cellulosic fibers, and combinations thereof. As another example, the natural fiber can be flax, hemp, jute, or kenaf. As another example, the modified natural fibers are selected from the group consisting of nitrocellulose, cellulose acetate, cellulose sulfonate, crosslinked starches, and combinations thereof. In some embodiments, the synthetic fibers are selected from the group consisting of polyester, polyacrylate, polyamine, polyamide, polysulfone, and combinations thereof. As another example, the reinforcing flexible material can have a polymer backing, such as polyester. A polymer suitable for use as a backing for the reinforcing flexible material can be any conventional polymer (see e.g., Nair et al. Prog. Poly. Sci 2007 32(8-9) 762-798; Miller Chou et al. Prog. Poly. Sci 2003 28 1223-1270).

As another example, the reinforcing flexible material can be pre-inmpregnated (prepeg material) with a resin matrix material. The prepreg material can be a resin inpregnated carbon fiber or fiberglass material. The prepreg material can be heated to create the final reinforcing flexible material.

Barrier Layer

As described herein, the barrier layer can form, or act as, a barrier between the reinforcing flexible material and the foam. Accordingly, the barrier layer can be made of any material known to those having ordinary skill in the art capable of such barrier properties. For example, the barrier layer can be any flexible material suitable for allowing a foam reaction mixture or foam to penetrate the barrier layer such that the foam or foam reaction mixture can be in contact with, adhere, or bind to the reinforcing flexible material.

A barrier layer can comprise two surfaces: a first surface and a second surface. For example, the barrier layer can be any material that allows a foam reaction mixture to penetrate the first and second surfaces of the barrier layer and adhere to the reinforcing flexible material. As another example, the barrier layer can allow the foam reaction mixture to pass through the barrier layer such that undesirable saturation and/or wetting of the reinforcing flexible material does not occur.

As described herein, undesirable saturation or wetting of the reinforcing flexible material can lead to deformation of the reinforcing flexible material when the liquid foam expands. Additionally, undesirable saturation or wetting of the foam reaction mixture can result in difficulty in applying a composite coating, such as, for example, an epoxy or resin. As described herein, in order to be effective, a composite coating should sufficiently wet the reinforcing flexible material, but if the reinforcing flexible material was already wetted (with, for example, the foam reaction mixture), the composite coating will not bond effectively. As such, as described herein, the barrier layer can be any material such that the reinforcing flexible material is not substantially deformed or the reinforcing flexible material is not wetted such that a composite coating can be effectively applied to the second side of the reinforcing flexible material.

As another example, a barrier layer can be at least partially permeable (e.g., much less permeable than conventional textile fabrics, higher than that of plastic films, and/or similar to that of coated papers and perforated plastic sheets), semi-permeable (e.g., only specific portions of the material are permeable, partially permeable, or selectively permeable), or selectively permeable (e.g., only permeable, partially permeable, or semi-permeable to certain compounds or materials), thus allowing the passage of a foam reaction mixture. As another example, a barrier layer can comprise plastic resin or thermoplastic. In some embodiments, the barrier layer is a perforated plastic film. In other embodiments, the barrier layer is in the form of a film, sheet, membrane, or an applied material, such as, for example, a sprayed on material, that forms a permeable membrane.

The use of the barrier layer can allow for a stronger product made with either GBA or LBA blown foam. The barrier layer restricts the amount of wetting of the reinforcing flexible material. If no barrier layer is present, less reinforcing flexible material would be available for the laminate construction because a higher percentage of the reinforcing flexible material would have been wetted out by the foam without the barrier layer in between the reinforcing flexible material and the foam.

As such, the use of the barrier layer, such as, for example, a perforated plastic film, can allow for the reinforcing flexible material to be wet out less by the foam reaction mixture. Thus more reinforcing flexible material for construction of the composite product. The higher glass content of a laminate makes for a stronger part.

As such, the more surface area of the reinforcing flexible material (e.g., higher the glass content of the laminate and less foam content) the stronger the product. As such, the materials and methods as described herein result in a laminate with a higher content of reinforcing flexible material, resulting in a stronger product compared to a product formed without a barrier layer.

As described herein, the barrier layer can be any flexible material suitable for allowing a foam reaction mixture or foam to penetrate the barrier layer such that the foam or foam reaction mixture is in contact with and adhere to the reinforcing flexible material. For example, the barrier material can be a flexible film or sheet.

A barrier layer can be any material suitable to provide a barrier between the reinforcing flexible material and the foam reaction mixture or foam. For example, a barrier layer can be a perforated plastic sheet (e.g., visqueen).

As another example, a barrier layer can comprise a polymer (e.g., plastic, thermoplastic, thermosetting polymer). A polymer suitable for use as a barrier layer can be any conventional polymer (see e.g., Nair et al. Prog. Poly. Sci 2007 32(8-9) 762-798; Miller Chou et al. Prog. Poly. Sci 2003 28 1223-1270). For example, a polymer suitable for use as a barrier layer can include polyethylene terephthalate (PET), recycled PET (rPET), nylon 610, nylon 8, polypropylene, polystyrene, cotton, rayons, hemp, polycarbonate, polyacetal, polyvinyl chloride, polyvinyl alcohol, nylon 6, nylon 610, polyethylene, ABS resins, PVC, melamine, melamine adhesive, Polypropylene, HDPE, LDPE, PETE, PETP, PET P, CPET, Dacron, Terylene, Laysan, Eastabond, Eastapak, Ektar, Grilpet, Impet, Kodapak, Kodar, Petra, Rynite, Sabre, Selar, Stanuloy, Valox, Celanex, Eastpac, Ektar, Mylar, Arnite, Centrolyte, Ertalyte, acrylic resin, alginate, caprolactone, collagen, chitosan, hyaluronic acid, hydrogel, hydroxybutyric acid, polyanhydride, polycaprolactone (PCL), poly(dimethylglycolic acid), polydioxanone (PDO), polyester, polyethylene, poly(ethylene glycol), poly(glycolide) (PGA), poly(glycolic acid), polyhydroxobutyrate, poly(2-hydroxyethyl-methacrylate), poly-lactide-co-glycolide (PLCG), poly(D,L-lactide-co-glycolide) (PLG), poly(lactide-co-glycolic acid) (PLGA), polylactide (PLA), polylactic acid (PLLA), poly-lactide-co-glycolide (PLCG), poly(methylethylglycolic acid), polymethylmethacrylate, polyphosphazenes, polyphosphoesters, polypropylene, poly(propylene fumarate), polyurethane (PU), or silicone rubber, or combinations or copolymers thereof. In some embodiments, the polymer can include a bioresorbable polyester or a copolymer selected from one or more of the group consisting of polycaprolactone (PCL), poly(D,L-lactide-co-glycolide) (PLG), polylactide (PLA), polylactic acid (PLLA), or poly-lactide-co-glycolide (PLCG). Nonlimiting examples of suitable polymers can include polycaprolactone, polylactide, polyglycolide, poly(lactide-glycolide), poly(propylene fumarate), poly(caprolactone fumarate), polyethylene glycol, poly(glycolide-co-caprolactone), polysaccharides (e.g., alginate), chitosan, polyphosphazene, polyacrylate, polyethylene oxide-polypropylene glycol block copolymer, fibrin, collagen, fibronectin, polyvinylpyrrolidone, hyaluronic acid, polycarbonates, polyamides, polyanhydrides, polyamino acids, polyortho esters, polyacetals, polycyanoacrylates, polyurethanes, polyacrylates, ethylene-vinyl acetate polymers or other acyl substituted cellulose acetates or derivatives thereof, or analogs, mixtures, combinations or derivatives of any of the above.

As another example, a suitable material for a barrier layer can include Polyester (PES), Polyethylene terephthalate (PET), Polyethylene (PE), High-density polyethylene (HDPE), Polyvinyl chloride (PVC), Polyvinylidene chloride (PVDC) (Saran), Polypropylene (PP), Polystyrene (PS), High impact polystyrene (HIPS), Polyamides (PA) (Nylons), Acrylonitrile butadiene styrene (ABS), Polyethylene/Acrylonitrile Butadiene Styrene (PE/ABS), Polycarbonate (PC), Polycarbonate/Acrylonitrile Butadiene Styrene (PC/ABS), Polyurethanes (PU), Maleimide/bismaleimide, Melamine formaldehyde (MF), Plastarch material, Phenolics (PF) or (phenol formaldehydes), Polyepoxide (epoxy), polyetheretherketone (PEEK), Polyetherimide (PEI) (Ultem), Polyimide, Polylactic acid (PLA), Polymethyl methacrylate (PMMA) (acrylic), Polytetrafluoroethylene (PTFE), Urea-formaldehyde (UF), Furan, Silicone, or Polysulfone.

In some embodiments, a polymer for use in the barrier layer can comprise recycled PET (rPET) or PET bottles, thermoforms, or bales that contain a mixture of bottles and thermoforms. As another example, a polymer can comprise recycled plastic waste materials such as PET, polyethylene terephthalate, from 2-1 soda bottles; HDPE, high density polyethylene, natural, from 1 gallon milk jugs, grocery bags, HDPE, high density polyethylene, colored, from bottles, PVC, polyvinyl chloride, various bottle, pipes, flooring; LDPE, low density polyethylene, from film and trash bags, rigid containers; PP, polypropylene, from some food containers, battery cases, medical containers, PS, polystyrene, from carry-out containers, food containers, or vitamin bottles.

Polymers as described herein for use in the barrier layer can be high molecular weight or low molecular weight. For example, a barrier layer or a polymer can have an average molecular weight between about 1,000 g/mol and about 100,000 g/mol. For example, the barrier layer can comprise a polymer with or the barrier layer can have an average molecular weight of about 1,000 g/mol; about 2,000 g/mol; about 3,000 g/mol; about 4,000 g/mol; about 5,000 g/mol; about 6,000 g/mol; about 7,000 g/mol; about 8,000 g/mol; about 9,000 g/mol; about 10,000 g/mol; about 11,000 g/mol; about 12,000 g/mol; about 13,000 g/mol; about 14,000 g/mol; about 15,000 g/mol; about 16,000 g/mol; about 17,000 g/mol; about 18,000 g/mol; about 19,000 g/mol; about 20,000 g/mol; about 21,000 g/mol; about 22,000 g/mol; about 23,000 g/mol; about 24,000 g/mol; about 25,000 g/mol; about 26,000 g/mol; about 27,000 g/mol; about 28,000 g/mol; about 29,000 g/mol; about 30,000 g/mol; about 31,000 g/mol; about 32,000 g/mol; about 33,000 g/mol; about 34,000 g/mol; about 35,000 g/mol; about 36,000 g/mol; about 37,000 g/mol; about 38,000 g/mol; about 39,000 g/mol; about 40,000 g/mol; about 41,000 g/mol; about 42,000 g/mol; about 43,000 g/mol; about 44,000 g/mol; about 45,000 g/mol; about 46,000 g/mol; about 47,000 g/mol; about 48,000 g/mol; about 49,000 g/mol; about 50,000 g/mol; about 51,000 g/mol; about 52,000 g/mol; about 53,000 g/mol; about 54,000 g/mol; about 55,000 g/mol; about 56,000 g/mol; about 57,000 g/mol; about 58,000 g/mol; about 59,000 g/mol; about 60,000 g/mol; about 61,000 g/mol; about 62,000 g/mol; about 63,000 g/mol; about 64,000 g/mol; about 65,000 g/mol; about 66,000 g/mol; about 67,000 g/mol; about 68,000 g/mol; about 69,000 g/mol; about 70,000 g/mol; about 71,000 g/mol; about 72,000 g/mol; about 73,000 g/mol; about 74,000 g/mol; about 75,000 g/mol; about 76,000 g/mol; about 77,000 g/mol; about 78,000 g/mol; about 79,000 g/mol; about 80,000 g/mol; about 81,000 g/mol; about 82,000 g/mol; about 83,000 g/mol; about 84,000 g/mol; about 85,000 g/mol; about 86,000 g/mol; about 87,000 g/mol; about 88,000 g/mol; about 89,000 g/mol; about 90,000 g/mol; 91,000 g/mol; about 92,000 g/mol; about 93,000 g/mol; about 94,000 g/mol; about 95,000 g/mol; about 96,000 g/mol; about 97,000 g/mol; about 98,000 g/mol; about 99,000 g/mol; or about 100,000 g/mol. It is understood that recitation of the above discrete values includes a range between each recited value. It is understood that recitation of the above ranges includes discrete values between each recited range.

In addition to the above mentioned polymers, the barrier layer may contain auxiliary components comprising other high polymers, reinforcing agents or fillers, or mixture thereof. For example, auxiliary components can be nylon 6, nylon 66, nylon 610, nylon 8, polybutylene terephthalate (PBT), polyethylene, polypropylene, ABS resins, cotton, rayons, and hemp. Examples of the reinforcing agents or fillers are glass fibers, glass beads, glass powders, quartz, talc, cement, and powders and fibers of carbon, iron, copper, titanium oxide, molybdenum, or aluminum and any other materials which are compatible with the polymer.

If necessary, other additives such as pigments, dyes, fire-retarding chemicals and deterioration preventing agents may also be incorporated into the barrier layer in conjunction with the above described auxiliary components (e.g., high polymer or filler).

As described herein, a barrier layer can comprise a polymer. For example, the barrier layer can comprise any of the above polymers, derivatives or analogs thereof, auxiliary components, or mixtures thereof in an amount of about 1%, about 2%, about 3%, about 4%, about 5%, about 6%, about 7%, about 8%, about 9%, about 10%, 11%, about 12%, about 13%, about 14%, about 15%, about 16%, about 17%, about 18%, about 19%, about 20%, 21%, about 22%, about 23%, about 24%, about 25%, about 26%, about 27%, about 28%, about 29%, about 30%, 31%, about 32%, about 33%, about 34%, about 35%, about 36%, about 37%, about 38%, about 39%, about 40%, 41%, about 42%, about 43%, about 44%, about 45%, about 46%, about 47%, about 48%, about 49%, about 50%, 51%, about 52%, about 53%, about 54%, about 55%, about 56%, about 57%, about 58%, about 59%, about 60%, 61%, about 62%, about 63%, about 64%, about 65%, about 66%, about 67%, about 68%, about 69%, about 70%, 71%, about 72%, about 73%, about 74%, about 75%, about 76%, about 77%, about 78%, about 79%, about 80%, 81%, about 82%, about 83%, about 84%, about 85%, about 86%, about 87%, about 88%, about 89%, about 90%, 91%, about 92%, about 93%, about 94%, about 95%, about 96%, about 97%, about 98%, about 99%, or about 100%. It is understood that recitation of the above discrete values includes a range between each recited value. It is understood that recitation of the above ranges includes discrete values between each recited range.

As described herein, another suitable material for a barrier layer can be an extruded sheet of plastic comprising plastic from recycled water bottles (e.g., PET).

The barrier layer can have any width suitable for use in creating a barrier between the foam reaction mixture and the reinforcing flexible material. For example, the barrier layer can have a width of at least between about 25 inches and about 72 inches. For example, the width of the barrier layer can be about 1 inch, about 2 inches, about 3 inches, about 4 inches, about 5 inches, about 6 inches, about 7 inches, about 8 inches, about 9 inches, about 10 inches, 11 inches, about 12 inches, about 13 inches, about 14 inches, about 15 inches, about 16 inches, about 17 inches, about 18 inches, about 19 inches, about 20 inches, 21 inches, about 22 inches, about 23 inches, about 24 inches, about 25 inches, about 26 inches, about 27 inches, about 28 inches, about 29 inches, about 30 inches, 31 inches, about 32 inches, about 33 inches, about 34 inches, about 35 inches, about 36 inches, about 37 inches, about 38 inches, about 39 inches, about 40 inches, 41 inches, about 42 inches, about 43 inches, about 44 inches, about 45 inches, about 46 inches, about 47 inches, about 48 inches, about 49 inches, about 50 inches, 51 inches, about 52 inches, about 53 inches, about 54 inches, about 55 inches, about 56 inches, about 57 inches, about 58 inches, about 59 inches, about 60 inches, 61 inches, about 62 inches, about 63 inches, about 64 inches, about 65 inches, about 66 inches, about 67 inches, about 68 inches, about 69 inches, about 70 inches, 71 inches, about 72 inches, about 73 inches, about 74 inches, about 75 inches, about 76 inches, about 77 inches, about 78 inches, about 79 inches, about 80 inches, 81 inches, about 82 inches, about 83 inches, about 84 inches, about 85 inches, about 86 inches, about 87 inches, about 88 inches, about 89 inches, about 90 inches, 91 inches, about 92 inches, about 93 inches, about 94 inches, about 95 inches, about 96 inches, about 97 inches, about 98 inches, about 99 inches, about 100 inches, 101 inches, about 102 inches, about 103 inches, about 104 inches, about 105 inches, about 106 inches, about 107 inches, about 108 inches, about 109 inches, about 110 inches, 111 inches, about 112 inches, about 113 inches, about 114 inches, about 115 inches, about 116 inches, about 117 inches, about 118 inches, about 119 inches, about 120 inches, 121 inches, about 122 inches, about 123 inches, about 124 inches, or about 125 inches. It is understood that recitation of the above discrete values includes a range between each recited value. It is understood that recitation of the above ranges includes discrete values between each recited range.

The barrier layer should be thin enough so that when the liquid foam expands, it can contact and bond with the reinforcing flexible material through the one or more pores in the barrier layer. For example, the barrier layer can have a thickness of about 0.5 mm to about 5 mm, about 0.5 mm to about 3 mm, or about 0.5 mm to about 1 mm.

In further embodiments, the barrier layer can have any thickness suitable for use in a process for producing a reinforced composite structure. For example, the barrier layer can have a thickness of between about 0.1 mil and 125 mil. For example, the barrier layer can have a thickness between about 1 mil and about 10 mil. As another example, the barrier layer thickness can be about 0.10 mil, about 0.15 mil, about 0.20 mil, about 0.25 mil, about 0.30 mil, about 0.35 mil, about 0.40 mil, about 0.45 mil, about 0.50 mil, about 0.55 mil, about 0.60 mil, about 0.65 mil, about 0.70 mil, about 0.80 mil, about 0.85 mil, about 0.90 mil, about 1.0 mil, about 1.10 mil, about 1.15 mil, about 1.20 mil, about 1.25 mil, about 1.30 mil, about 1.35 mil, about 1.40 mil, about 1.45 mil, about 1.50 mil, about 1.55 mil, about 1.60 mil, about 1.65 mil, about 1.70 mil, about 1.80 mil, about 1.85 mil, about 1.90 mil, about 2.0 mil, about 2.10 mil, about 2.15 mil, about 2.20 mil, about 2.25 mil, about 2.30 mil, about 2.35 mil, about 2.40 mil, about 2.45 mil, about 2.50 mil, about 2.55 mil, about 2.60 mil, about 2.65 mil, about 2.70 mil, about 2.80 mil, about 2.85 mil, about 2.90 mil, about 3.0 mil, about 3.10 mil, about 3.15 mil, about 3.20 mil, about 3.25 mil, about 3.30 mil, about 3.35 mil, about 3.40 mil, about 3.45 mil, about 3.50 mil, about 3.55 mil, about 3.60 mil, about 3.65 mil, about 3.70 mil, about 3.80 mil, about 3.85 mil, about 3.90 mil, about 4.0 mil, about 4.10 mil, about 4.15 mil, about 4.20 mil, about 4.25 mil, about 4.30 mil, about 4.35 mil, about 4.40 mil, about 4.45 mil, about 4.50 mil, about 4.55 mil, about 4.60 mil, about 4.65 mil, about 4.70 mil, about 4.80 mil, about 4.85 mil, about 4.90 mil, about 5.0 mil, about 5.10 mil, about 5.15 mil, about 5.20 mil, about 5.25 mil, about 5.30 mil, about 5.35 mil, about 5.40 mil, about 5.45 mil, about 5.50 mil, about 5.55 mil, about 5.60 mil, about 5.65 mil, about 5.70 mil, about 5.80 mil, about 5.85 mil, about 5.90 mil, about 6.0 mil, about 6.10 mil, about 6.15 mil, about 6.20 mil, about 6.25 mil, about 6.30 mil, about 6.35 mil, about 6.40 mil, about 6.45 mil, about 6.50 mil, about 6.55 mil, about 6.60 mil, about 6.65 mil, about 6.70 mil, about 6.80 mil, about 6.85 mil, about 6.90 mil, about 7.0 mil, about 7.10 mil, about 7.15 mil, about 7.20 mil, about 7.25 mil, about 7.30 mil, about 7.35 mil, about 7.40 mil, about 7.45 mil, about 7.50 mil, about 7.55 mil, about 7.60 mil, about 7.65 mil, about 7.70 mil, about 7.80 mil, about 7.85 mil, about 7.90 mil, about 8.0 mil, about 8.10 mil, about 8.15 mil, about 8.20 mil, about 8.25 mil, about 8.30 mil, about 8.35 mil, about 8.40 mil, about 8.45 mil, about 8.50 mil, about 8.55 mil, about 8.60 mil, about 8.65 mil, about 8.70 mil, about 8.80 mil, about 8.85 mil, about 8.90 mil, about 9.0 mil, about 9.10 mil, about 9.15 mil, about 9.20 mil, about 9.25 mil, about 9.30 mil, about 9.35 mil, about 9.40 mil, about 9.45 mil, about 9.50 mil, about 9.55 mil, about 9.60 mil, about 9.65 mil, about 9.70 mil, about 9.80 mil, about 9.85 mil, about 9.90 mil, about 10.0 mil, about 10.10 mil, about 10.15 mil, about 10.20 mil, about 10.25 mil, about 10.30 mil, about 10.35 mil, about 10.40 mil, about 10.45 mil, about 10.50 mil, about 10.55 mil, about 10.60 mil, about 10.65 mil, about 10.70 mil, about 10.80 mil, about 10.85 mil, about 10.90 mil, about 11.0 mil, about 11.10 mil, about 11.15 mil, about 11.20 mil, about 11.25 mil, about 11.30 mil, about 11.35 mil, about 11.40 mil, about 11.45 mil, about 11.50 mil, about 11.55 mil, about 11.60 mil, about 11.65 mil, about 11.70 mil, about 11.80 mil, about 11.85 mil, about 11.90 mil, about 12.0 mil, about 12.10 mil, about 12.15 mil, about 12.20 mil, about 12.25 mil, about 12.30 mil, about 12.35 mil, about 12.40 mil, about 12.45 mil, about 12.50 mil, about 12.55 mil, about 12.60 mil, about 12.65 mil, about 12.70 mil, about 12.80 mil, about 12.85 mil, about 12.90 mil, about 13.0 mil, about 13.10 mil, about 13.15 mil, about 13.20 mil, about 13.25 mil, about 13.30 mil, about 13.35 mil, about 13.40 mil, about 13.45 mil, about 13.50 mil, about 13.55 mil, about 13.60 mil, about 13.65 mil, about 13.70 mil, about 13.80 mil, about 13.85 mil, about 13.90 mil, about 14.0 mil, about 14.10 mil, about 14.15 mil, about 14.20 mil, about 14.25 mil, about 14.30 mil, about 14.35 mil, about 14.40 mil, about 14.45 mil, about 14.50 mil, about 14.55 mil, about 14.60 mil, about 14.65 mil, about 14.70 mil, about 14.80 mil, about 14.85 mil, about 14.90 mil, about 15.0 mil, about 15.10 mil, about 15.15 mil, about 15.20 mil, about 15.25 mil, about 15.30 mil, about 15.35 mil, about 15.40 mil, about 15.45 mil, about 15.50 mil, about 15.55 mil, about 15.60 mil, about 15.65 mil, about 15.70 mil, about 15.80 mil, about 15.85 mil, about 15.90 mil, about 16.0 mil, about 16.10 mil, about 16.15 mil, about 16.20 mil, about 16.25 mil, about 16.30 mil, about 16.35 mil, about 16.40 mil, about 16.45 mil, about 16.50 mil, about 16.55 mil, about 16.60 mil, about 16.65 mil, about 16.70 mil, about 16.80 mil, about 16.85 mil, about 16.90 mil, about 17.0 mil, about 17.10 mil, about 17.15 mil, about 17.20 mil, about 17.25 mil, about 17.30 mil, about 17.35 mil, about 17.40 mil, about 17.45 mil, about 17.50 mil, about 17.55 mil, about 17.60 mil, about 17.65 mil, about 17.70 mil, about 17.80 mil, about 17.85 mil, about 17.90 mil, about 18.0 mil, about 18.10 mil, about 18.15 mil, about 18.20 mil, about 18.25 mil, about 18.30 mil, about 18.35 mil, about 18.40 mil, about 18.45 mil, about 18.50 mil, about 18.55 mil, about 18.60 mil, about 18.65 mil, about 18.70 mil, about 18.80 mil, about 18.85 mil, about 18.90 mil, about 19.0 mil, about 19.10 mil, about 19.15 mil, about 19.20 mil, about 19.25 mil, about 19.30 mil, about 19.35 mil, about 19.40 mil, about 19.45 mil, about 19.50 mil, about 19.55 mil, about 19.60 mil, about 19.65 mil, about 19.70 mil, about 19.80 mil, about 19.85 mil, about 19.90 mil, about 20.0 mil, about 20.10 mil, about 20.15 mil, about 20.20 mil, about 20.25 mil, about 20.30 mil, about 20.35 mil, about 20.40 mil, about 20.45 mil, about 20.50 mil, about 20.55 mil, about 20.60 mil, about 20.65 mil, about 20.70 mil, about 20.80 mil, about 20.85 mil, about 20.90 mil, about 21.0 mil, about 21.10 mil, about 21.15 mil, about 21.20 mil, about 21.25 mil, about 21.30 mil, about 21.35 mil, about 21.40 mil, about 21.45 mil, about 21.50 mil, about 21.55 mil, about 21.60 mil, about 21.65 mil, about 21.70 mil, about 21.80 mil, about 21.85 mil, about 21.90 mil, about 22.0 mil, about 22.10 mil, about 22.15 mil, about 22.20 mil, about 22.25 mil, about 22.30 mil, about 22.35 mil, about 22.40 mil, about 22.45 mil, about 22.50 mil, about 22.55 mil, about 22.60 mil, about 22.65 mil, about 22.70 mil, about 22.80 mil, about 22.85 mil, about 22.90 mil, about 23.0 mil, about 23.10 mil, about 23.15 mil, about 23.20 mil, about 23.25 mil, about 23.30 mil, about 23.35 mil, about 23.40 mil, about 23.45 mil, about 23.50 mil, about 23.55 mil, about 23.60 mil, about 23.65 mil, about 23.70 mil, about 23.80 mil, about 23.85 mil, about 23.90 mil, about 24.0 mil. It is understood that recitation of the above discrete values includes a range between each recited value. It is understood that recitation of the above ranges includes discrete values between each recited range. A mil is one thousandth of an inch (0.001″).

As another example, the barrier layer can have a thickness of between about 1 mil and 125 mil. For example, the barrier layer thickness can be about 1 mil, about 2 mil, about 3 mil, about 4 mil, about 5 mil, about 6 mil, about 7 mil, about 8 mil, about 9 mil, about 10 mil, 11 mil, about 12 mil, about 13 mil, about 14 mil, about 15 mil, about 16 mil, about 17 mil, about 18 mil, about 19 mil, about 20 mil, 21 mil, about 22 mil, about 23 mil, about 24 mil, about 25 mil, about 26 mil, about 27 mil, about 28 mil, about 29 mil, about 30 mil, 31 mil, about 32 mil, about 33 mil, about 34 mil, about 35 mil, about 36 mil, about 37 mil, about 38 mil, about 39 mil, about 40 mil, 41 mil, about 42 mil, about 43 mil, about 44 mil, about 45 mil, about 46 mil, about 47 mil, about 48 mil, about 49 mil, about 50 mil, 51 mil, about 52 mil, about 53 mil, about 54 mil, about 55 mil, about 56 mil, about 57 mil, about 58 mil, about 59 mil, about 60 mil, 61 mil, about 62 mil, about 63 mil, about 64 mil, about 65 mil, about 66 mil, about 67 mil, about 68 mil, about 69 mil, about 70 mil, 71 mil, about 72 mil, about 73 mil, about 74 mil, about 75 mil, about 76 mil, about 77 mil, about 78 mil, about 79 mil, about 80 mil, 81 mil, about 82 mil, about 83 mil, about 84 mil, about 85 mil, about 86 mil, about 87 mil, about 88 mil, about 89 mil, about 90 mil, 91 mil, about 92 mil, about 93 mil, about 94 mil, about 95 mil, about 96 mil, about 97 mil, about 98 mil, about 99 mil, about 100 mil, 101 mil, about 102 mil, about 103 mil, about 104 mil, about 105 mil, about 106 mil, about 107 mil, about 108 mil, about 109 mil, about 110 mil, 111 mil, about 112 mil, about 113 mil, about 114 mil, about 115 mil, about 116 mil, about 117 mil, about 118 mil, about 119 mil, about 120 mil, 121 mil, about 122 mil, about 123 mil, about 124 mil, or about 125 mil. It is understood that recitation of the above discrete values includes a range between each recited value. It is understood that recitation of the above ranges includes discrete values between each recited range. A mil is one thousandth of an inch (0.001″).

Pores and Perforations.

According to a preferred method, a foam can be applied to the second surface of the barrier layer, and the foam expands through at least one pore in the barrier layer to contact and bond to the reinforcing flexible material. In a preferred method, the barrier layer comprises a plurality of pores. The at least one pore can be a small pore having a diameter of between about 0.01 mm to about 1.00 mm. For example, the diameter can be between about 0.3 mm to about 0.7 mm. As another example, the diameter of the at least one pore can be about 0.5 mm. It is desirable that the at least one pore is large enough to allow a foam (e.g., a sprayed foam, liquid foam reaction mixture, or liquid phase) to expand through the one or more pores in the barrier layer and contact and/or adhere to a reinforcing flexible material (e.g., a fiberglass mat) without undesirable saturation while maximizing the amount of glass for impregnation allowing for production of a stronger laminate than can be made using conventional approaches that use foam agents comprising environmentally unhealthy greenhouse gases applied without a barrier layer present between the foaming agent and reinforcing layer.

In an exemplary embodiment, the barrier layer comprises a plurality of pores arranged such that the foam reaction mixture can come into contact with the reinforcing flexible material.

As described herein, the barrier layer can have perforations, such that the perforations provide openings in the barrier layer that allow for the reaction mixture to pass through the opening, but also limit the amount of foam that passes through the mat. The size of the openings and number of openings can depend on the foam reaction mixture composition. For example, if the reaction mixture is viscous, a larger number of openings and/or larger sized openings may be used.

As another example, the barrier layer can have about 1 to about 10,000 pores per square foot or about 100 to about 6,000 per square foot. It is understood that recitation of the above ranges includes discrete values between each recited range.

As described herein, the pores of the perforated sheet can be spaced apart. For example, the center spacing of pores can be from about 1/16 inch to about 3 inches or 1/16 inch to about 1 inch. As another example, the center spacing of the pores can be about 1/16 inch, about ⅛ inch, about 3/16 inch, about ¼ inch, about 5/16 inch, about ⅜ inch, about 7/16 inch, about ½ inch, about 9/16 inch, about ⅝ inch, about 11/16 inch, about % inch, about 13/16 inch, about ⅞ inch, about 15/16 inch, about 1 inch, 1 1/16 inch, about 1⅛ inch, about 1 3/16 inch, about 1¼ inch, about 1 5/16 inch, about 1⅜ inch, about 1 7/16 inch, about 1½ inch, about 1 9/16 inch, about 1⅝ inch, about 1 11/16 inch, about 1¾ inch, about 1 13/16 inch, about 1⅞ inch, about 1 15/16 inch, about 2 inches, 2 1/16 inches, about 2⅛ inches, about 2 3/16 inches, about 2¼ inches, about 2 5/16 inches, about 2⅜ inches, about 2 7/16 inches, about 2½ inches, about 2 9/16 inches, about 2⅝ inches, about 2 11/16 inches, about 2¾ inches, about 2 13/16 inches, about 2⅞ inches, about 2 15/16 inches, or about 3 inches. It is understood that recitation of the above discrete values includes a range between each recited value. It is understood that recitation of the above ranges includes discrete values between each recited range.

As another example, the pore pattern can be staggered or random.

As described herein, a barrier layer can comprise open areas. For example, the barrier layer can comprise open areas of about 1%, about 2%, about 3%, about 4%, about 5%, about 6%, about 7%, about 8%, about 9%, about 10%, 11%, about 12%, about 13%, about 14%, about 15%, about 16%, about 17%, about 18%, about 19%, about 20%, 21%, about 22%, about 23%, about 24%, about 25%, about 26%, about 27%, about 28%, about 29%, about 30%, 31%, about 32%, about 33%, about 34%, about 35%, about 36%, about 37%, about 38%, about 39%, about 40%, 41%, about 42%, about 43%, about 44%, about 45%, about 46%, about 47%, about 48%, about 49%, about 50%, 51%, about 52%, about 53%, about 54%, about 55%, about 56%, about 57%, about 58%, about 59%, about 60%, 61%, about 62%, about 63%, about 64%, about 65%, about 66%, about 67%, about 68%, about 69%, about 70%, 71%, about 72%, about 73%, about 74%, about 75%, about 76%, about 77%, about 78%, about 79%, about 80%, 81%, about 82%, about 83%, about 84%, about 85%, about 86%, about 87%, about 88%, about 89%, about 90%, 91%, about 92%, about 93%, about 94%, about 95%, about 96%, about 97%, about 98%, about 99%, or about 100%. It is understood that recitation of the above discrete values includes a range between each recited value. It is understood that recitation of the above ranges includes discrete values between each recited range.

As another example, a barrier layer as described herein can be perforated with pores or openings. A barrier layer, as described herein, can further comprise at least one pore or opening. For example, the barrier layer can comprise a plurality of pores or openings. The at least one pore or opening can be a small pore or opening having a diameter of from about 0.01 mm to about 5.00 mm. For example, the diameter can be between about 0.3 mm and about 0.7 mm. As another example, the diameter of the at least one pore or opening can be about 0.5 mm. As another example, the diameter of the pore or opening can be about 0.010 mm, about 0.015 mm, about 0.020 mm, about 0.025 mm, about 0.030 mm, about 0.035 mm, about 0.040 mm, about 0.045 mm, about 0.050 mm, about 0.055 mm, about 0.060 mm, about 0.065 mm, about 0.070 mm, about 0.080 mm, about 0.085 mm, about 0.090 mm, 0.10 mm, about 0.15 mm, about 0.20 mm, about 0.25 mm, about 0.30 mm, about 0.35 mm, about 0.40 mm, about 0.45 mm, about 0.50 mm, about 0.55 mm, about 0.60 mm, about 0.65 mm, about 0.70 mm, about 0.80 mm, about 0.85 mm, about 0.90 mm, about 1.0 mm, about 1.10 mm, about 1.15 mm, about 1.20 mm, about 1.25 mm, about 1.30 mm, about 1.35 mm, about 1.40 mm, about 1.45 mm, about 1.50 mm, about 1.55 mm, about 1.60 mm, about 1.65 mm, about 1.70 mm, about 1.80 mm, about 1.85 mm, about 1.90 mm, about 2.0 mm, about 2.10 mm, about 2.15 mm, about 2.20 mm, about 2.25 mm, about 2.30 mm, about 2.35 mm, about 2.40 mm, about 2.45 mm, about 2.50 mm, about 2.55 mm, about 2.60 mm, about 2.65 mm, about 2.70 mm, about 2.80 mm, about 2.85 mm, about 2.90 mm, about 3.0 mm, about 3.10 mm, about 3.15 mm, about 3.20 mm, about 3.25 mm, about 3.30 mm, about 3.35 mm, about 3.40 mm, about 3.45 mm, about 3.50 mm, about 3.55 mm, about 3.60 mm, about 3.65 mm, about 3.70 mm, about 3.80 mm, about 3.85 mm, about 3.90 mm, about 4.0 mm, about 4.10 mm, about 4.15 mm, about 4.20 mm, about 4.25 mm, about 4.30 mm, about 4.35 mm, about 4.40 mm, about 4.45 mm, about 4.50 mm, about 4.55 mm, about 4.60 mm, about 4.65 mm, about 4.70 mm, about 4.80 mm, about 4.85 mm, about 4.90 mm, or about 5.0 mm. It is understood that recitation of the above discrete values includes a range between each recited value. It is understood that recitation of the above ranges includes discrete values between each recited range.

It is desirable that the at least one pore is large enough to allow a foam reaction mixture to penetrate the first and second surfaces of the barrier layer and bond to the reinforcing layer without undesirable saturation and/or wetting of the reinforcing flexible material that can lead to deformation of the reinforcing flexible material when the liquid foam expands.

Foam

The foam can be applied and expanded through the at least one pore of the barrier layer. The foam can be capable of expanding to a sufficient degree through the at least one pore so as to contact and bond with the reinforcing flexible material without saturating or wetting the reinforcing flexible material.

The foam can be a single component foam or a multi-component foam. In embodiment, the foam can be a two-component foam. In another embodiment the foam reaction mixture has a liquid phase. The foam or blowing agent can be free or substantially free of a halogenated hydrocarbon, such as a HCFO (e.g., HCFO-1233zd, HCFO-1223, HCFO-1233xf), a HFO (e.g., HFO-1234yf, HFO-1234ze), a CFC, a HCFC (e.g., HCFC-22), or a HFC (e.g., HFC 134a). The blowing agent can be a hydrocarbon (HC) blowing agent.

A foam reaction mixture can be a liquid reaction mixture or comprise a liquid phase. In some embodiments, the foam is applied by spraying. In other embodiments, the foam is applied by pouring.

In one embodiment, the foam reaction mixture can be in a liquid foam phase comprising (a) an isocyanate, (b) at least one polyol, and (c) at least one blowing agent. The polyol can have a hydroxyl number of from about 150 to about 800, about 150 to about 200, about 200 to about 250, about 250 to about 300, about 300 to about 350, about 350 to about 400, about 400 to about 450, about 450 to about 500, about 500 to about 550, about 550 to about 600, about 600 to about 650, about 650 to about 700, about 700 to about 750, and about 750 to about 800. Non-limiting examples of the polyol include a polyalkoxylated amine, a polyalkoxylated ether, and a polyester polyol. In another embodiment, the at least one blowing agent can be a methyl formate, a derivative of methyl formate, a precursor of methyl formate, or a combination thereof. In some embodiments, the foam further comprises water as a blowing agent.

A foam or foam reaction mixture can be any foam or foam reaction mixture known in the art. For example, a foam reaction mixture can be a single component foam or a multi-component foam. As an example, the foam reaction mixture can be a two-component foam. In another embodiment, the foam reaction mixture can be a liquid foam reaction mixture. The foam reaction mixture or foam can be free or at least substantially free (e.g., comprising less than about 15%, less than about 10%, less than about 5%, or less than about 1%) of any halogenated blowing agent. For example, a halogenated blowing agent can comprise a chlorinated or fluorinated blowing agent. As another example, a halogenated blowing agent can be HFO, HCFO, CFC, HCFC, HFC, or any halogenated hydrocarbon.

As described herein, the foam can be formed from a liquid foam reaction mixture of (a) an isocyanate, (b) at least one polyol, and (c) at least one blowing agent. For example, the polyol can have a hydroxyl number of from about 150 to about 800. As another example, the polyol according to the method can be at least one of a polyalkoxylated amine, a polyalkoxylated ether, or a polyester polyol combinations, and the like. As another example, the at least one blowing agent can be an alkyl alkanoate, such as methyl formate, a derivative of methyl formate, a precursor of methyl formate, or derivatives or combinations thereof. As another example, the foam can further comprise water as a blowing agent.

As described herein, the foam can be any type of foam known in the art. For example, the foam can be a polyurethane foam, a polyethylene foam, a polystyrene foam, an extruded polystyrene (XPS), a polyester foam, a polypropylene foam, polyisocyanurate (PIR) foam, a thermoplastic foam, and elastomeric foam, neoprene, a foam rubber, a syntactic foam, a shape memory polymer foam, an integral skin foam, or a ballistic foam, or a mixture thereof.

As described herein, the foam can be a rigid foam or a flexible foam.

As described herein, the foam can be an open-cell (also known as reticulated foams, e.g., a liquid can flow through the entire structure, displacing the air) or closed cell foam (e.g., the gas pockets are sealed from each other).

Blowing Agent

The foam as described herein can be produced using a blowing agent.

As described herein, a blowing agent can be a chemical blowing agent, a physical blowing agent, or a mixed chemical/physical blowing agent. A chemical blowing agent can give off gas with a chemical reaction or decomposition (e.g., CO₂ or N₂ gas formation). For example, a chemical blowing agent can be isocyanate and water, azo-, hydrazine or other nitrogen-based materials, or sodium bicarbonate, or a combination or mixture thereof. A physical blowing agent can have a boiling point at or near room temperature or expands with heat. For example, a physical blowing agent can be liquid carbon dioxide (which boils to give gaseous form).

A blowing agent can be an exothermic blowing agent. For example, an exothermic blowing agent can comprise azodicarbonamide (ADC), oxy-bis-benzene-sulfonylhydrazide (OBSH), toluenesulfonyl-hydrazide (TSH), benzenesulfonyl-hydrazide (BSH), toluenesulfonyl-semicarbazide (TSH), 5-phenyltetrazole (5 PT), or DNPT, or a combination or mixture thereof.

Blowing agents can comprise alkyl alkanoate (e.g., methyl formate, ethyl formate), water, a hydrocarbon (HC), a chlorofluorocarbon (CFC), hydrochlorofluorocarbon (HCFC), or a hydrofluorocarbon (HFC), olefins, hydrofluorolefins (HFO), or a combination or mixture thereof. An alkyl alkanoate can comprise methyl formate or ethyl formate.

An alkyl alkanoate can include any one or more of the below.

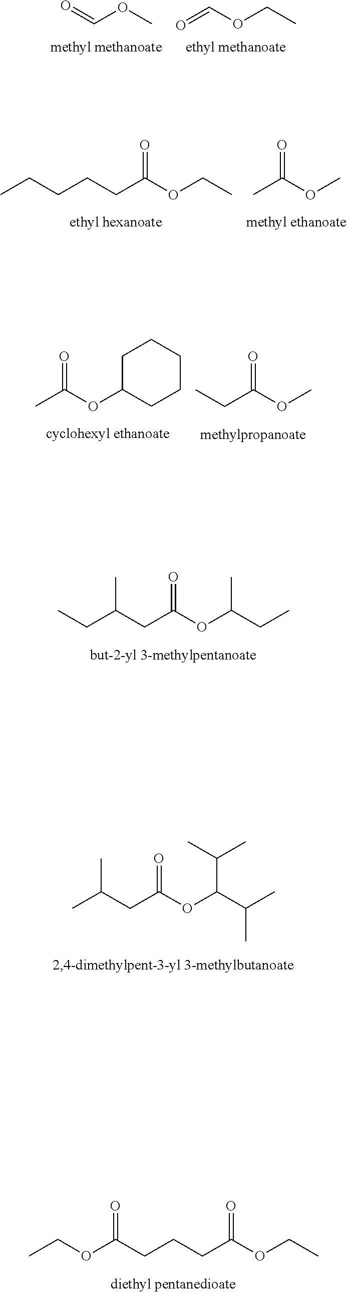

Other physical blowing agents can include any one or more of the below.

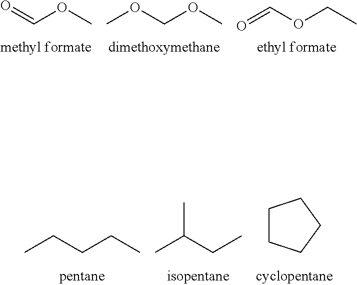

As described herein, the foam can be produced by a froth or gaseous or gas blowing agent (GBA) foams or a liquid blowing agent (LBA). For example, the foams produced can be a GBA foam or an LBA foam.

Compositions and methods of producing foam can be carried out as described in U.S. application Ser. No. 10/026,306 filed on 18 Dec. 2001 and issued as U.S. Pat. No. 6,753,357 on 22 Jun. 2004; U.S. application Ser. No. 10/499,375 filed on 11 Feb. 2005 and issued as U.S. Pat. No. 7,635,723 on 22 Dec. 2009; U.S. application Ser. No. 11/195,983 filed on 3 Aug. 2005; U.S. application Ser. No. 12/646,959 filed on 12 Dec. 2009 issued as U.S. Pat. No. 8,568,061 on 29 Oct. 2013; and U.S. application Ser. No. 14/036,528 filed on 25 Sep. 2013, each of which are incorporated by reference in their entireties.

Composite Coating

A composite coating can be any material suitable for use in applications to produce a surface finish. For example, a composite coating can be a laminate, a resin, an epoxy, or a polymer (such as a polyester material, i.e., fine and microfine polyester veils). The resin can comprise polyester, cross-linked polyester, styrene acrylic, co-polyester, vinyl ester, epoxy resin, or polyurethane. The resin can be suitable for use as an adhesive carrier. As another example, the laminate can comprise the reinforcing flexible material and the foam.

Reinforcing a Composite Structure

As described herein, the disclosure provides a method of reinforcing a composite structure. An exemplary method comprises the steps of: placing a first surface of a barrier layer on top of or above a reinforcing flexible material, wherein the barrier layer comprises at least one pore, preferably a plurality of pores, and more preferably a plurality of pores per square foot; and applying a foam to the barrier layer so that when the foam expands it passes through the at least one pore of the barrier layer and contacts and bonds to the reinforcing flexible material without saturating or wetting the reinforcing flexible material.

The reinforced composite structure, as described herein, can be manufactured to pass coast guard floatation requirements.

Any numbers expressing quantities of ingredients, constituents, reaction conditions, and so forth used in the specification are to be understood as being modified in all instances by the term “about.” Notwithstanding that the numerical ranges and parameters setting forth the broad scope of the subject matter presented herein are approximations, the numerical values set forth are indicated as precisely as possible. Any numerical value, however, may inherently contain errors or inaccuracies as evident from the standard deviation found in their respective measurement techniques. None of the features recited herein should be interpreted as invoking 35 U.S.C. § 112(f), unless the term “means” is explicitly used.

Although the present disclosure has been described in connection with preferred embodiments thereof, it will be appreciated by those skilled in the art that additions, deletions, modifications, and substitutions not specifically described may be made without departing from the spirit and scope of the exemplary embodiments.

Definitions and methods described herein are provided to better define the present disclosure and to guide those of ordinary skill in the art in the practice of the present disclosure. Unless otherwise noted, terms are to be understood according to conventional usage by those of ordinary skill in the relevant art.

In some embodiments, numbers expressing quantities of ingredients, properties such as molecular weight, reaction conditions, and so forth, used to describe and claim certain embodiments of the present disclosure are to be understood as being modified in some instances by the term “about.” In some embodiments, the term “about” is used to indicate that a value includes the standard deviation of the mean for the device or method being employed to determine the value. In some embodiments, the numerical parameters set forth in the written description and attached claims are approximations that can vary depending upon the desired properties sought to be obtained by a particular embodiment. In some embodiments, the numerical parameters should be construed in light of the number of reported significant digits and by applying ordinary rounding techniques. Notwithstanding that the numerical ranges and parameters setting forth the broad scope of some embodiments of the present disclosure are approximations, the numerical values set forth in the specific examples are reported as precisely as practicable. The numerical values presented in some embodiments of the present disclosure may contain certain errors necessarily resulting from the standard deviation found in their respective testing measurements. The recitation of ranges of values herein is merely intended to serve as a shorthand method of referring individually to each separate value falling within the range. Unless otherwise indicated herein, each individual value is incorporated into the specification as if it were individually recited herein.

In some embodiments, the terms “a” and “an” and “the” and similar references used in the context of describing a particular embodiment (especially in the context of certain of the following claims) can be construed to cover both the singular and the plural, unless specifically noted otherwise. In some embodiments, the term “or” as used herein, including the claims, is used to mean “and/or” unless explicitly indicated to refer to alternatives only or the alternatives are mutually exclusive.

The terms “comprise,” “have” and “include” are open-ended linking verbs. Any forms or tenses of one or more of these verbs, such as “comprises,” “comprising,” “has,” “having,” “includes” and “including,” are also open-ended. For example, any method that “comprises,” “has” or “includes” one or more steps is not limited to possessing only those one or more steps and can also cover other unlisted steps. Similarly, any composition or device that “comprises,” “has” or “includes” one or more features is not limited to possessing only those one or more features and can cover other unlisted features.

All methods described herein can be performed in any suitable order unless otherwise indicated herein or otherwise clearly contradicted by context. The use of any and all examples, or exemplary language (e.g. “such as”) provided with respect to certain embodiments herein is intended merely to better illuminate the present disclosure and does not pose a limitation on the scope of the present disclosure otherwise claimed. No language in the specification should be construed as indicating any non-claimed element essential to the practice of the present disclosure.

Groupings of alternative elements or embodiments of the present disclosure disclosed herein are not to be construed as limitations. Each group member can be referred to and claimed individually or in any combination with other members of the group or other elements found herein. One or more members of a group can be included in, or deleted from, a group for reasons of convenience or patentability. When any such inclusion or deletion occurs, the specification is herein deemed to contain the group as modified thus fulfilling the written description of all Markush groups used in the appended claims.

All publications, patents, patent applications, and other references cited in this application are incorporated herein by reference in their entirety for all purposes to the same extent as if each individual publication, patent, patent application or other reference was specifically and individually indicated to be incorporated by reference in its entirety for all purposes. Citation of a reference herein shall not be construed as an admission that such is prior art to the present disclosure.

Having described the present disclosure in detail, it will be apparent that modifications, variations, and equivalent embodiments are possible without departing the scope of the present disclosure defined in the appended claims. Furthermore, it should be appreciated that all examples in the present disclosure are provided as non-limiting examples.

### EXAMPLES

The following non-limiting examples are provided to further illustrate the present disclosure. It should be appreciated by those of skill in the art that the techniques disclosed in the examples that follow represent approaches the inventors have found function well in the practice of the present disclosure, and thus can be considered to constitute examples of modes for its practice. However, those of skill in the art should, in light of the present disclosure, appreciate that many changes can be made in the specific embodiments that are disclosed and still obtain a like or similar result without departing from the spirit and scope of the present disclosure.

### Example 1

The following example describes the method of making a stringer system for a boat.

First, a flexible reinforcing material made of a flexible woven fiberglass sheet was placed into a form. Second, a barrier layer made of a perforated plastic sheet with perforations that were 0.045″ in diameter was placed on top of the woven fiberglass sheet that was placed into the form. The perforations of the plastic sheet of the barrier layer allowed enough foam to pass through the openings and adhere the foam to the flexible woven fiberglass sheet in the form while limiting the amount of foam that went into the woven fiberglass sheet.

A liquid polyurethane foam reaction mixture was placed onto the perforated plastic sheet using a methyl formate blowing agent. A lid or cover can be placed onto the form which can force the foam reaction mixture and foam into the perforations in the plastic to more firmly adhere to the woven fiberglass sheet, but it is not necessary.

After the foam cured, the foam, perforated plastic, and flexible woven fiberglass was removed from the form. No deforming or excessive wetting was observed.

An epoxy or other material can be used to coat the reinforced composite structure.

The plastic used for the testing was much higher quality of plastic than would be required in this process. As such, an inexpensive piece of visqueen plastic sheeting with perforations would also work to allow the correct amount of foam to flow through the openings.

1. A method, the method comprising:
(i) providing a reinforcing flexible material;
(ii) providing a barrier layer; and
(iii) providing a foam reaction mixture;
wherein,
the barrier layer is placed between the reinforcing flexible material and the foam reaction mixture;
the barrier layer comprises at least one pore; and
the foam reaction mixture expands through the at least one pore such that the foam contacts and adheres to the reinforcing flexible material.

2. The method according to claim 1, wherein
(i) the barrier layer comprises a plurality of pores;
(ii) the foam reaction mixture comprises a liquid blowing agent or a gas blowing agent; or
(iii) the reinforcing flexible material comprises at least one material selected from the group consisting of a fiberglass, a carbon fiber, an aramid fiber, a polyethylene fiber, a polypropylene fiber, a polyester fiber, and a mixture thereof.

3. The method according to claim 1, wherein the foam is obtained by combining:
(a) an isocyanate;
(b) at least one polyol having a hydroxyl number of from about 150 to about 800 and is selected from the group consisting of a polyalkoxylated amine, a polyalkoxylated ether, and a polyester polyol; and
(c) at least one blowing agent selected from the group consisting of methyl formate, a derivative of methyl formate, and a precursor of methyl formate.

4. The method according to claim 3, wherein the combining further comprises adding water as a blowing agent.

5. The method according to claim 1, wherein the foam is substantially free of a halogenated hydrocarbon, optionally, hydrofluoroolefin, hydrochlorofluoroolefin, chlorofluorocarbon, a hydrochlorofluorocarbon, or hydrofluorocarbon.

6. The method according to claim 1, wherein the reinforcing flexible material comprises at least one material selected from the group consisting of a fiberglass, a carbon fiber, an aramid fiber, a polyethylene fiber, a polypropylene fiber, a polyester fiber, and a mixture thereof.

7. The method according to claim 1, wherein the reinforcing flexible material comprises woven fiberglass.

8. The method according to claim 1, wherein the barrier layer:
(i) comprises a plurality of pores; or
(ii) is a plastic sheet.

9. The method according to claim 1, further comprising coating at least a portion of the reinforced composite structure with a composite coating.

10. The method according to claim 1, wherein the reinforcing flexible material has a first side and a second side and the first side is in contact with the barrier layer and the second side is in contact with a composite coating.

11. The method according to claim 1, wherein the barrier layer is at least one of semi-permeable or selectively permeable.

12. A structure, comprising:
(i) a reinforcing flexible material;
(ii) a barrier layer comprising a first surface, a second surface, and a pore, the second surface positioned such that it contacts the reinforcing flexible material; and
(iii) a foam in contact with the first surface of the barrier layer and the reinforcing flexible material and positioned such that it extends through the pore of the barrier layer to contact the reinforcing flexible material.

13. The structure according to claim 12, wherein
(i) the barrier layer comprises a plurality of pores;
(ii) the foam reaction mixture comprises a liquid blowing agent or a gas blowing agent; or
(iii) the reinforcing flexible material comprises at least one material selected from the group consisting of a fiberglass, a carbon fiber, an aramid fiber, a polyethylene fiber, a polypropylene fiber, a polyester fiber, and a mixture thereof.

14. The structure according to claim 12, wherein the foam comprises:
(a) an isocyanate;
(b) at least one polyol having a hydroxyl number of from about 150 to about 800 and is selected from the group consisting of a polyalkoxylated amine, a polyalkoxylated ether, and a polyester polyol; and
(c) at least one blowing agent selected from the group consisting of methyl formate, a derivative of methyl formate, and a precursor of methyl formate.

15. The structure according to claim 14, wherein the foam further comprises water as a blowing agent.

16. The structure according to claim 12, wherein the foam is substantially free of a halogenated hydrocarbon, optionally, a hydrofluoroolefin, a hydroflurochloroolefin, a chlorofluorocarbon, a hydrochlorofluorocarbon, or a hydrofluorocarbon.

17. The structure according to claim 12, wherein the reinforcing flexible material comprises at least one material selected from the group consisting of a fiberglass, a carbon fiber, an aramid fiber, a polyethylene fiber, a polypropylene fiber, a polyester fiber, and a mixture thereof.

18. The structure according to claim 12, wherein the reinforced flexible material is a woven fiberglass.

19. The structure according to claim 11, wherein the barrier layer:
(i) comprises a plurality of pores; or
(ii) is a plastic sheet.

20. The structure according to claim 12, further comprising a composite coating.

21. The structure according to claim 12, wherein the reinforcing flexible material has a first side and a second side and the first side is in contact with the barrier layer and the second side is in contact with a composite coating.

22. The structure according to claim 12, wherein the barrier layer prevents the reinforcing flexible material from deforming.

23. The structure according to claim 12, wherein the barrier layer prevents the reinforcing flexible material from overwetting from the foam.

24. The structure according to claim 12, wherein the barrier layer is at least one of semi-permeable or selectively permeable.

25. A portion of a watercraft, aircraft, or vehicle, comprising:
(i) a reinforcing flexible material;
(ii) a barrier layer comprising a first surface, a second surface, and a pore, the second surface positioned such that it contacts the reinforcing flexible material; and
(iii) a foam in contact with the first surface of the barrier layer and the reinforcing flexible material and positioned such that it extends through the pore of the barrier layer to contact the reinforcing flexible material.

26. The portion of a watercraft, aircraft, or vehicle of claim 25, wherein the portion is selected from a stringer, a bulkhead, a hull, a deck stiffener, a beam, a fuel tank support, a structural member, a long-span stiffener, a corner stiffener, a hatch and swim platform reinforcement, an insulated compartment, a fish box, a structural component for a flat-bed trailer, a structural component for a truck body, a structural component for a bus, a structural component for a recreational vehicle, and a structural component for an aircraft.
